(19) United States
(12) Patent Application Publication
(10) Pub. No.: US 2021/0407009 A1
(43) Pub. Date: Dec. 30, 2021

(54) METHODS AND SYSTEMS FOR AUTOMATICALLY GENERATING AND EXECUTING A SET OF PARAMETERIZED INSTRUCTION TEMPLATES

(71) Applicant: RISE WEALTH TECHNOLOGIES GMBH, Grünwald (DE)

(72) Inventor: Nikolay NADIRASHVILI, Grünwald (DE)

(21) Appl. No.: 17/280,855

(22) PCT Filed: Oct. 4, 2018
(86) PCT No.: PCT/EP2018/077025

§ 371 Date: Mar. 26, 2021

(51) Int. Cl. G06Q 40/06; G06Q 40/04; G06Q 10/04; G06N 20/00; G06N 5/00

(52) U.S. Cl. CPC G06Q 40/06; G06Q 40/04; G06N 5/003; G06N 20/00; G06Q 10/04

(57) ABSTRACT

A computer-implemented method for automatically generating a set of parameterized instruction templates, comprising the steps: obtaining a first set of instruction templates; for each instruction template, obtaining one or more distinct parameter sets; instantiating each instruction template with the one or more distinct parameter sets; jointly evaluating the instantiated instruction templates, using a cost function; adapting one or more parameter sets of the instruction templates, based on the evaluation; repeating the previous steps of evaluating and adapting the instruction templates, until the output of the cost function fulfills a given criterion; and storing the instruction templates and their adapted parameter sets in a non-volatile, computer-readable medium.

### FIELD OF THE INVENTION

This invention relates to the specific processes and methods of training software to accomplish specific tasks by processing large amounts of data and recognizing patterns in the data. In particular, the invention relates to the automatic generation of parameterized, conditional templates for algorithmic trading.

### BACKGROUND OF THE INVENTION

Generating new trading ideas requires enormous amounts of data processing. In particular, strategy scaling is one of the crucial problems in algorithmic trading. Given that a strategy, which is based on historical data, is believed to have positive results in the future, there is no straightforward way to scale the strategy, namely to increase the trading volumes, without severely affecting its relative returns and all measures of return-risk ratios. The reason for that is that the slippage per lot ratio is dependent on the volumes the strategy is trading. In other words, the order book is not infinitely liquid and the volume starts to affect the prices in a non-beneficial manner, namely when buying a larger amount of lots one either gets a higher average price, or does execute the orders only partially.

The situation for selling is inverse. Thus, one cannot maintain a good performance by increasing the size of orders. What is possible in order to tackle the problem is to create more strategies that do not enter (or exit the positions) at exactly the same times and prices, by introducing small perturbations in the coefficients of the strategy.

The standard approach is to first create a parametrized trading algorithm and then optimize the parameters in order to achieve the best possible performance and risk measured results, using cross validation to avoid overfitting. The second part consists of finding the optimum parameters and making the system robust.

However, creating a parametrized trading algorithm requires a creative though process of traders and quantitative analysts and is highly dependent on their experience and it is extremely hard to estimate how long this process takes.

It is therefore an object of the invention to provide methods and systems for generating and executing a set of parameterized instruction templates automatically.

### SUMMARY OF THE INVENTION

These objects are achieved by a method and a system according to the independent claims. Advantageous embodiments are defined in the dependent claims.

In a first aspect, the invention provides a computer-implemented method for automatically generating a set of parameterized instruction templates, comprising the steps: obtaining a first set of instruction templates; for each instruction template, obtaining one or more distinct parameter sets; instantiating each instruction template with the one or more distinct parameter sets; jointly evaluating the instantiated instruction templates, using a cost function; adapting one or more parameter sets of the instruction templates, based on the evaluation; repeating the previous steps of evaluating and adapting the instruction templates, until the output of the cost function fulfills a given criterion; and storing the instruction templates and their adapted parameter sets in a non-volatile, computer-readable medium.

The instruction templated may comprise a parameterized set of rules.

The instruction templates may be evaluated against a database of empirical data. Preferably, the empirical data is cleaned, prior to using it in the evaluation. Cleaning the data may comprise the steps of identifying incorrect, invalid, duplicated, incomplete information.

The instruction templates may be initialized with random data.

The instruction templates may comprise a trigger, defining one or more conditions for the execution of the template. The triggers may be adapted, based on the evaluation. The triggers may comprise one or more of the adapted parameters.

According to a second aspect, the invention also proposes a computer-implemented method for executing a set of parameterized instruction templates, characterized in that the parameterized instruction templates are automatically generated according to one of the methods of the previous claims.

The set of parameterized instruction templates may be executed against a stream of real-time data. Advantageously, the data has been scraped from the Internet, using known techniques.

The advantage of a fully machine learning approach is that a creative process of generating trading ideas (with unpredictable timespans and a lot of coding involved) is automated and many ideas can be generated in a very limited amount of time.

### BRIEF DESCRIPTION OF THE FIGURES

These and other aspects and advantages of the present invention will be described more fully, by way of example, in the following detailed description of a preferred embodiment of the invention, in connection with the drawing, in which

FIG. 1 shows a flowchart of a computer-implemented method for automatically generating a set of parameterized instruction templates according to an embodiment of the invention.

FIG. 2 shows a flowchart of a computer-implemented method for executing a set of parameterized instruction templates according to an embodiment of the invention.

FIG. 3 shows a block diagram of a strategy or instruction template (instantiated) according to an embodiment of the invention.

FIG. 4a shows a decision tree that can contain multiple technical indicators, one in each node.

FIG. 4b shows an example of a trading system trigger generated according to an embodiment of the invention.

FIG. 5 shows a succession of training and test cycles according to an embodiment of the invention.

FIG. 6 shows a performance diagram of a method according to an embodiment of the invention.

FIG. 7 shows a heat map of different Sharpe Ratio strategies.

### DETAILED DESCRIPTION OF THE PREFERRED EMBODIMENTS

The preferred embodiments of the present invention provide systems and methods that have a number of characteristics in order to address the main problems in building trading strategies.

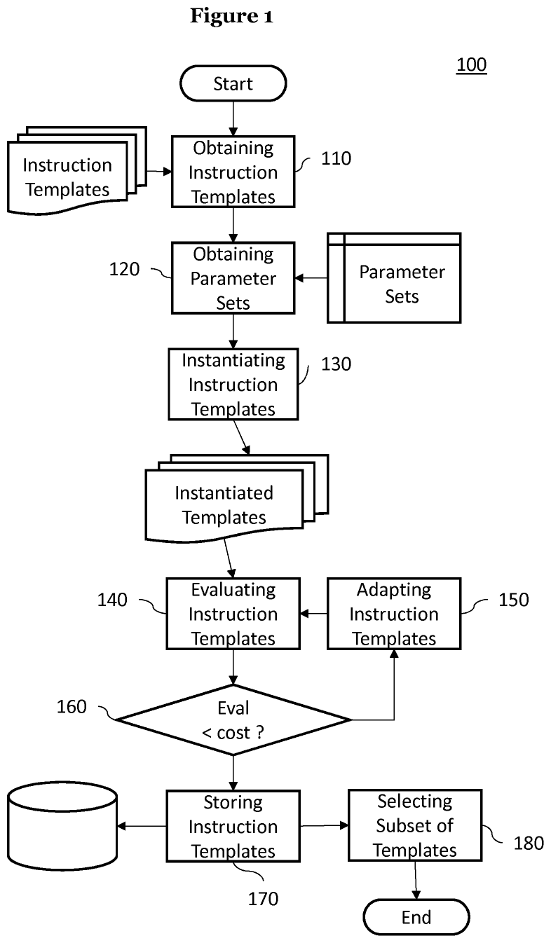

FIG. 1 shows a flowchart of a computer-implemented method 100 for automatically generating a set of parameterized instruction templates according to an embodiment of the invention.

In step 110, the method obtains a first set of instruction templates. In step 120, the method obtains, for each instruction template, one or more distinct parameter sets. In step 130, the method instantiates each instruction template with the one or more distinct parameter sets. In step 140, the method jointly evaluates the instantiated instruction templates, using a cost function. In step 150, the method adapts one or more parameter sets of the instruction templates, based on the evaluation. In step 160, the method checks whether the evaluated cost meets a given cost criterion and repeats the previous steps of evaluating and adapting the instruction templates, until the output of the cost function fulfills the given criterion. In step 170, the method stores the instruction templates and their adapted parameter sets in a non-volatile, computer-readable medium, if the cost criterion is met.

Thus, a big part of manual work of devising and parametrizing a new strategy can be eliminated. In particular, the method creates a large number of parametrized algorithms automatically, thus saving time and effort. This systematic way of generating new trading systems allows for a more accurate scheduling of resources.

All generated trading strategies have a very low correlation with each other. Each strategy is traded with different instruments catering to the individual characteristics of instruments such as volatility patterns, liquidity, trading time. This way, one may diversify between different instruments and within the strategy by using different parameters.

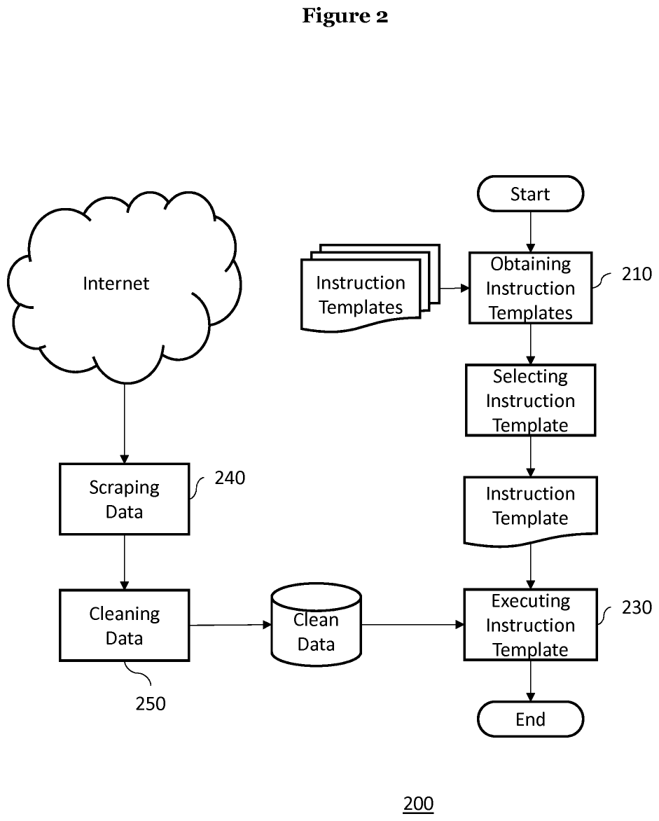

FIG. 2 shows a flowchart of a computer-implemented method 200 for executing a set of parameterized instruction templates according to an embodiment of the invention.

In step 210, the method obtains a set of parameterized instruction templates. In step 220, the method selects a parameterized instruction template and executes it in step 230, against a set of data obtained from a database.

In a preferred embodiment, the data obtained from the Internet is cleansed. This process identifies incorrect, invalid, duplicated, incomplete information from our backtest database. Data issues are rectified until the dataset is accurate, current and complete

Once data is cleansed, the system selects a number of indicators from a library of about 100 technical/statistical indicators and starts analyzing the data set. A good selection of technical indicators forms the basis of the analysis performed subsequently by the system. The system does not only take technical indicators into consideration but also fundamental data points such as supply and demand information for commodities for example.

Only a relatively small number of indicators should be selected for each back test iteration. Preferably, the system tends to select indicators that are contrasting. The selection and combination of indicators is random

In a preferred embodiment, a strategy generator produces a number of strategies, each of which can be decomposed into a trading template also called “strategy template” and a strategy trigger also called “trigger”.

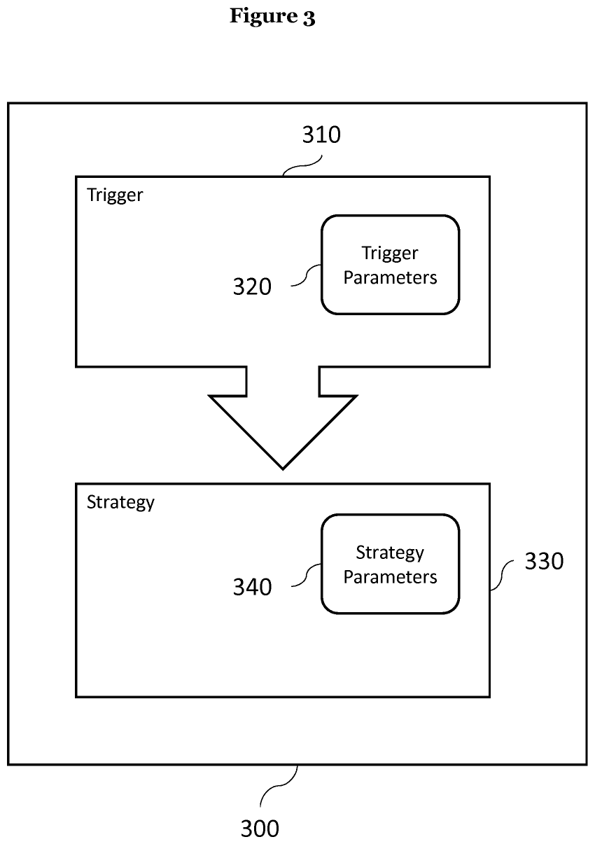

FIG. 3 shows a schema of an instantiated strategy or instruction template 300. The strategy includes a trigger 310, i.e. a set of conditions that must be present if the template is to be executed. The trigger also includes trigger parameters 320 that can be instantiated to form sub-strategies with different values. The template also includes a strategy 330, that is, a series of actions that are executed when the conditions of the trigger are met. The strategy can also include strategy parameters 340 that can be instantiated to form sub-strategies with different values.

In a preferred embodiment of the invention, a strategy template is a parametrized set of trading rules, that benefits from some specific market behavior, e.g. in trending markets or volatile markets. A realization of a strategy template is a strategy template where the parameters are instantiated. In a preferred embodiment, not all parameter settings have to be profitable strategies in all market conditions but are at least profitable under certain market circumstances. In the same embodiment, a trigger is then a method that identifies the potentially profitable market conditions from potentially loosing market conditions. It is a set of rules, which can be represented as a parse tree that initiates the trading strategy implicitly predicting, that the market conditions are going to be right.

A trigger can be synthesized automatically by a so-called trigger generator. A trigger generator is a function that produces a trigger using some heuristics, e.g. genetic programming methods.

Strategies can also be synthesized automatically by a so-called strategy generator. A strategy generator is a function that produces tuples of triggers and trading template realizations, by jointly optimizing the parameters in a trading template, creating trigger trees and initiating constants. Thereby, the following methodologies can be used: Random Forest; Gradient Boosting; Lasso Regression. The analysis of a large number of possible combinations per minute scales with additional servers.

For training purposes, the maximal number of instruments are applied and instead of training one model for each of them multiple models are trained, which can be applied to all of them.

In an alternative embodiment, a method for producing a strategy comprises the steps:
1) Defining a strategy template
2) Defining a cost function
3) Defining a random context using bootstrapping, a statistical method
4) Generating different triggers using genetic programming methods that use the parameters from a strategy template, without initializing Constant nodes
5) For each of the triggers optimizing jointly the values for Constant nodes and parameter values in a strategy template to maximize the cost function
6) After cross validation choosing best trigger-template combination:

By repeating the steps 3 to 6, the required number of low correlated strategies is produced.

The algorithm uses known methods such as Genetic Programming, Evolutionary Algorithms, Decision Trees, Ensembling and Boosting to find hidden insights in data without explicitly being programmed for where to look or what to conclude.

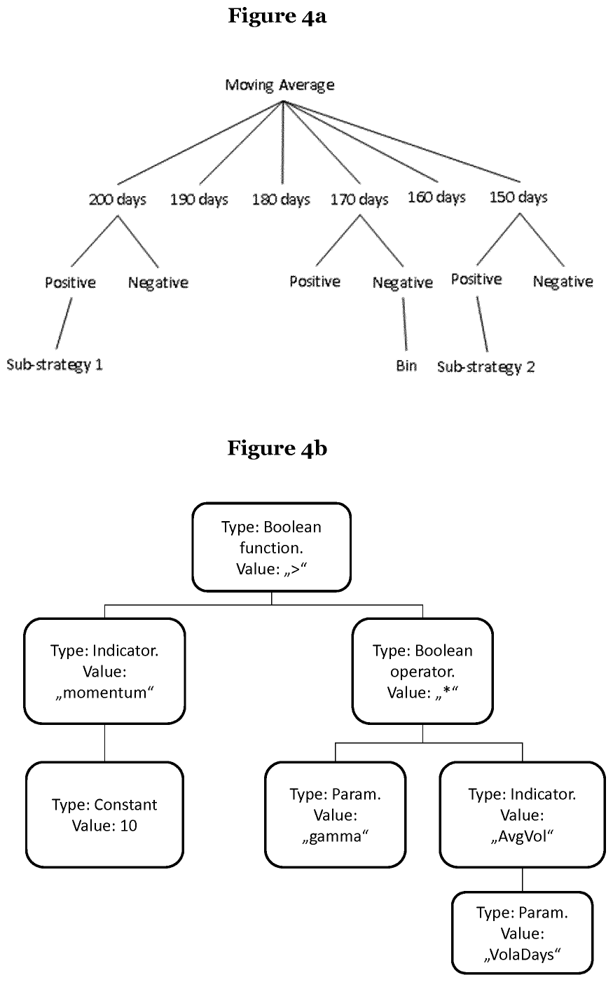

Examples of a number of sub-strategies are shown in FIG. 4a. An example of a trigger is shown in FIG. 4b.

FIG. 4a shows a decision tree that can contain multiple technical indicators, one in each node.

The outcome of this process is a set of different and uncorrelated strategies, trading single lots, for each of the underlyings. All strategies are traded with equal weights and thus provide an inherent portfolio diversification. Generating at least 15 uncorrelated strategy per underlying reduces the risk profile of the strategy by about 80%. Therefore, the minimum number of sub-strategies that are produced is a crucial part of the risk management process at strategy level.

FIG. 4b shows an example of a trading system trigger generated according to an embodiment of the invention. The tree returns a Boolean value, which being true triggers the strategy. More particularly, the trigger defines that if a 10-period momentum indicator is more than some multiple of market volatility averaged over several days then a strategy is started.

A representation of triggers as trees enables their straightforward automatic generation with the methods of genetic programming. The nodes of the trees represent either some operations on the child nodes and the trading context, or constants and parameters. Only functions with no arguments, constants and parameters might be the leaves of the tree.

Definition of node types:
1. Constant node—is a node that returns a constant, which cannot be referenced in a trading template, so it is an unshared constant. It might be an integer, real or logic value. Generally, it can be any constant structure.
2. Parameter node—is also a constant-valued node, but unlike a constant node, it is referenced in a trading template.
3. Function node—is a node that returns the result of applying some function to each child nodes. In extreme cases a function node does not need a child node and still might return different values if it samples from some predefined probability distribution. Special operators like “if” and “while” can also be represented as function nodes.
4. Context function node (also called Indicator node). Unlike pure Function nodes context functions operate not only on its child nodes but also on the trading context, that does not have to be passed explicitly to the function as another node. Trading context contains all the relevant market data.
5. All of the nodes have return units (like dollars, seconds, squared minutes and so on) and types (integer, real, Boolean, vector). Units are used during the tree generation in order to avoid meaningless expressions (e.g. summation of dollars and seconds). Function nodes as well as Context function nodes have unit and type restrictions on its child nodes.

Context is a dataset relevant for making trading decisions. It is subdivided into market context and trading context. Market context can contain all system relevant information from the exchange e.g. prices and volumes as well as fundamental data. Trading context contains all metrics of the account and the history of orders and trades.

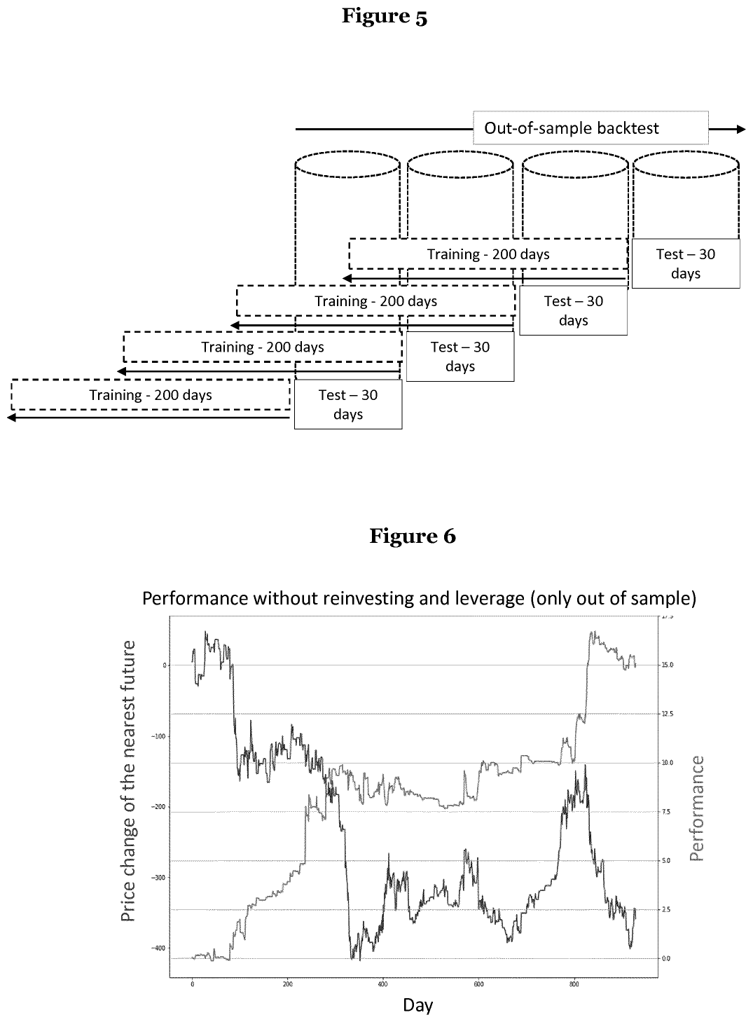

FIG. 5 shows a succession of training and test cycles according to an embodiment of the invention. More particularly, the retraining process happens every 1-5 days, depending on market volatility. The backtest period is 200 days followed by a 30 day out of sample test.

The result is one set of strategies with 100 sub-strategies.

FIG. 6 shows a performance diagram of a method according to an embodiment of the invention.

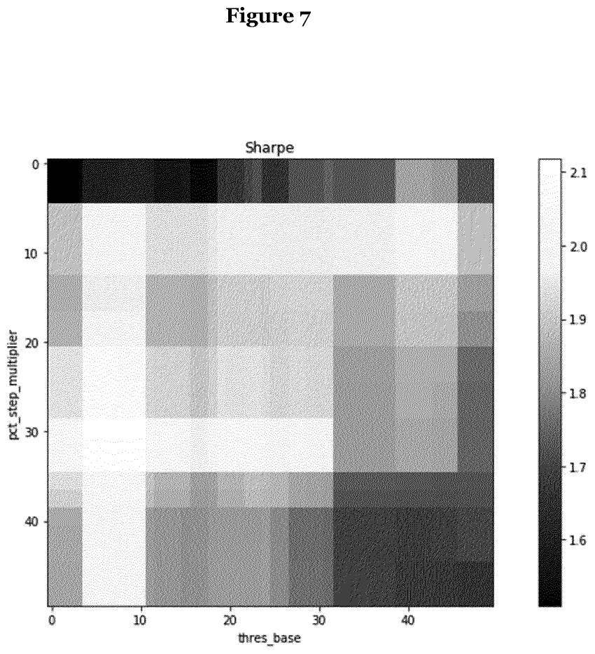

FIG. 7 shows a heat map of different Sharpe Ratio strategies.

Selection criteria:
Sharpe Ratio
ROI
Trading capital required

### IMPLEMENTATION

The prototype system constructed by the inventors runs on three cloud servers with 250 Gigabyte RAM and 12 cores each. The preferred embodiments are constructed in Java and Python, which are essentially platform independent coding languages. Use of Java permits that other embodiments may be translated into other languages if necessary.

Example embodiments may also include computer program products. The computer program products may be stored on computer-readable media for carrying or having computer-executable instructions or data structures. Such computer-readable media may be any available media that can be accessed by a general purpose or special purpose computer. By way of example, such computer-readable media may include RAM, ROM, EPROM, EEPROM, CD-ROM or other optical disk storage, magnetic disk storage or other magnetic storage devices, or any other medium that may be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is an example of a computer-readable medium. Combinations of the above are also to be included within the scope of computer readable media. Computer-executable instructions include, for example, instructions and data, which cause a general purpose computer, a special purpose computer, or a special purpose processing device to perform a certain function or group of functions. Furthermore, computer-executable instructions include, for example, instructions that have to be processed by a computer to transform the instructions into a format that is executable by a computer. The computer-executable instructions may be in a source format that is compiled or interpreted to obtain the instructions in the executable format. When the computer-executable instructions are transformed, a first computer may for example transform the computer executable instructions into the executable format and a second computer may execute the transformed instructions.

The computer-executable instructions may be organized in a modular way so that a part of the instructions may belong to one module and a further part of the instructions may belong to a further module. However, the differences between different modules may not be obvious and instructions of different modules may be intertwined.

Example embodiments have been described in the general context of method operations, which may be implemented in one embodiment by a computer program product including computer-executable instructions, such as program code, executed by computers in networked environments. Generally, program modules include for example routines, programs, objects, components, or data structures that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such operations.

Some embodiments may be operated in a networked environment using logical connections to one or more remote computers having processors. Logical connections may include for example a local area network (LAN) and a wide area network (WAN). The examples are presented here by way of example and not limitation.

Such networking environments are commonplace in office-wide or enterprise-wide computer networks, intranets and the Internet. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing the overall system or portions might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer readable media provide nonvolatile storage of computer executable instructions, data structures, program modules and other data for the computer.

Software and web implementations could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, hardware implementations, or equipment for receiving manual inputs.

### SUMMARY

The invention works by combining large amounts of data with fast, iterative processing and intelligent algorithms, allowing the software to learn automatically from patterns or features in the data. Advanced algorithms have been developed and combined in new ways to analyze more data faster and at multiple levels. This intelligent processing is key to identifying tradable events and optimizing unique scenarios and ultimately automates analytical trade model building.

The advantage of a fully machine learning approach is that a creative process of generating ideas (with unpredictable timespans and a lot of coding involved) is automated and much more of those ideas can be generated in a very limited amount of time.

The training set gets much larger, thus allowing us to train more complex models, avoiding overfitting.

Strategies can adapt more efficiently to changing market conditions for each of the instruments. For example, if the instrument exhibited high volatility and high liquidity during its entire backtest history, then the model trained only on it, will most likely not be profitable in different conditions (e.g. low volatility, low liquidity). By training the model on a wide range of instruments the resulting trading strategy will be much more robust as it was trained in a variety of different market conditions.

1. A computer-implemented method for automatically generating a set of parameterized instruction templates, the method comprising:
obtaining a first set of instruction templates;
for each instruction template, obtaining one or more distinct parameter sets;
instantiating each instruction template with the one or more distinct parameter sets;
jointly evaluating the instantiated instruction templates, using a cost function;
adapting one or more parameter sets of the instruction templates, based on the evaluation;
repeating the evaluating and adapting the instruction templates, until output of the cost function fulfills a given criterion; and
storing the instruction templates and their adapted parameter sets in a non-volatile, computer-readable medium.

2. The method of claim 1, wherein the instruction templated comprises a parameterized set of rules.

3. The method of claim 1, wherein the instruction templates are evaluated against a database of empirical data.

4. The method of claim 3, wherein the empirical data is cleaned, prior to using it in the evaluation.

5. The method of claim 4, wherein cleaning the empirical data comprises the steps of identifying one or more of incorrect, invalid, duplicated, and/or incomplete information.

6. The method of claim 1, wherein the instruction templates are initialized with random data.

7. The method of claim 1, wherein the instruction templates comprise a trigger, defining one or more conditions for execution of the template.

8. The method of claim 7, wherein the triggers are adapted, based on the evaluation.

9. The method of claim 8, wherein the triggers comprise one or more of the adapted parameters.

10. A computer-implemented method for executing a set of parameterized instruction templates, characterized in that the parameterized instruction templates are automatically generated according to claim 1.

11. The method of claim 10, wherein the set of parameterized instruction templates is executed against a stream of real-time data.

12. The method of claim 11, wherein the data is scraped from the Internet.
